(19) United States
(12) Patent Application Publication
(10) Pub. No.: US 2006/0027430 A1
(43) Pub. Date: Feb. 9, 2006

(54) Power-off brake

(76) Inventor: Juergen Strueber, Nuernberg (DE)

Correspondence Address: JACOBSON HOLMAN PLLC, 400 SEVENTH STREET N.W., SUITE 600, WASHINGTON, DC, 20004, US

(21) Appl. No.: 11/195,860

(22) Filed: Aug. 3, 2005

(30) Foreign Application Priority Data
Aug. 3, 2004 (DE) 10 2004 037 663.8

(51) Int. Cl. F16D 65/36

(52) U.S. Cl. 188/161; 188/156

(57) ABSTRACT

The invention relates to a power-off brake (1) with a coil (3) that is wound on an insulating spool (2) and is arranged in a magnetically conductive stator unit (4) and a magnet armature (5) that can move toward the stator unit (4) against the force of at least one return spring (6) when the coil (3) is energized. The object of the present invention is to create a power-off brake that is characterized by a simple design and an easy and reliable assembly. This object is achieved by the fact that the spool (2) is held by the at least one return spring (6) in the stator unit (4)

### CROSS-REFERENCE TO RELATED APPLICATIONS

This application claims priority of German application No. 10 2004 037 663.8, filed Aug. 3, 2004, which is incorporated by reference herein in its entirety.

### BACKGROUND OF THE INVENTION

1. Field of the Invention

The invention relates to a power-off brake (1) with a coil (3) that is wound on an insulating spool (2) and arranged in a magnetically conductive stator unit (4) and a magnet armature (5) that can move toward the stator unit (4) against the force of at least one return spring (6) when the coil (3) is energized.

2. Related Art

In known power-off brakes the spool is firmly connected to the stator unit using an additional process step, for instance, by adhesion, caulking or wobbling. The additional process steps delay the assembly time and increase the weight of the power-off brake under certain circumstances. Furthermore, they can also result in assembly defects and on the whole lower the cost-effectiveness of the power-off brake.

### SUMMARY OF THE INVENTION

Therefore, the object of the present invention is to create a power-off brake that is characterized by a simple design and an easy and reliable assembly.

This object is achieved by the fact that the spool (2) is held by the return spring (6) in the stator unit (4). This measure ensures that additional measures for attaching the spool in the stator unit are unnecessary. Moreover, this measure enables the simple design of the power-off brake and the manufacturing facilities, in particular, need not comprise any expensive equipment or machines for caulking or wobbling, thus enabling a more cost-effective creation of the power-off brake on the whole.

Further preferred embodiments of the present invention will become apparent upon review of the claims below.

In a particularly preferred embodiment of the present invention, the spool (2) comprises a molded part (7) that serves as a support surface for one end of the return spring (6). This molded part can be created while forming the spool, thus requiring no additional manufacturing costs.

The return spring (6) is advantageously supported on the other end on the magnet armature wherein the length of the return spring (6) and the distance between the molded part (7) and the magnet armature are adjusted to one another such that the return spring is pre-stressed even in the de-energized state of the coil. This measure prevents the occurrence of a clearance between the magnet armature, the return spring, the spool, and the stator unit, which could give rise to vibrations and noises. The design of the spring force can be determined using methods that are familiar to a person of skill in this art so as to avoid any resonances of the existing mass-spring system in the application.

In principle, it is also feasible to secure the spool in the stator unit using additional fastening measures. However, the essence of the invention is contained in the fact that only the return spring can ensure a secure retention of the spool in the stator unit so as to avoid any additional measures for fastening the spring.

The embodiment is arranged such that one or more pressure springs can be used as a return spring. These can be mounted in a simple manner and can be easily designed to meet various requirements with respect to compressive force and spring length. The use of only one pressure spring arranged in an annular space (8) inside the stator unit (4) and radially inside or outside the coil (3) ensures a particularly easy and secure assembly.

Should the use of several pressure springs be preferred for reasons of geometry, it is advisable to arrange these evenly over the 360° angle of the annular space (8) inside the stator unit (4) and radially inside or outside the coil (3) so that an even distribution of force on the magnet armature is ensured.

From the aspect of mounting techniques it can be advantageous to provide the spool (2) or the spool (2) and the stator unit (4) with one or more retainer pockets, each of which can accommodate a return spring, particularly if the return spring can be accommodated in the spool (2) using a form-fit or force-fit connection. In this manner it is possible to pre-assemble the return spring in the spool, thus forming an independent module that can be supplied in this form in the assembly line.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 illustrates a sectional view of a power-off brake in accordance with the invention and

FIG. 2 illustrates a sectional view of a power-off brake in accordance with prior art.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

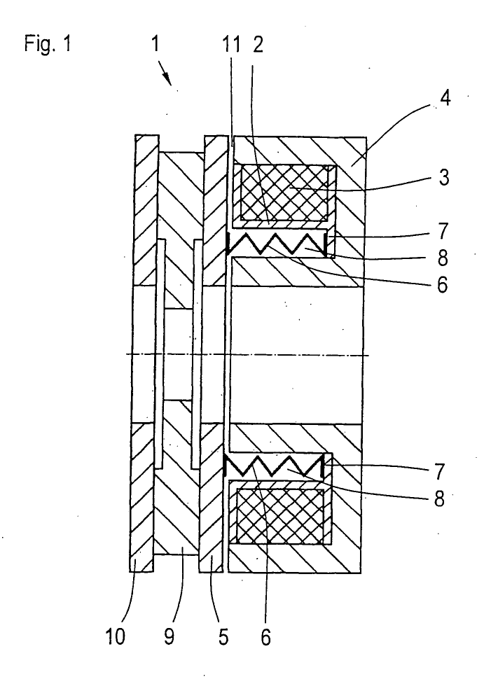

FIG. 1 illustrates a sectional view of a power-off brake 1 in accordance with the invention. It comprises a coil 3 that is wound on an insulating spool 2 and is arranged in a magnetically conductive stator unit 4 and a magnet armature 5 that can move toward the stator unit 4 against the force of at least one return spring 6 when the coil 3 is energized, wherein the spool 2 is held by the return spring 6 in the stator unit 4. The return spring 6 is supported on the other end on a molded part 7 of the spool 2 and is located inside an annular space 8 between the spool 2 and the stator unit 4. The power-off brake is used for the purpose of braking and then holding the output shaft of an actuating drive in an off state. For this purpose a brake disk 9 is provided that works in combination with the magnet armature on one side and with a brake lining on the other side that is fixed to the housing. Both combinations have a high coefficient of friction. In the de-energized state of the coil the magnet armature is in the braking position by forming an air gap 11 between the magnet armature 5 and the stator unit 4. When the coil 3 is energized, the return spring 6 is compressed around this air gap 11.

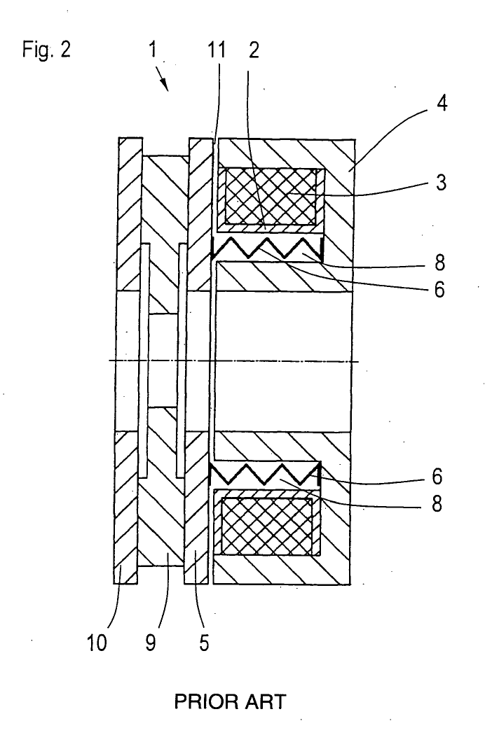

FIG. 2 illustrates a -sectional view of a power-off brake 1 in accordance with prior art. It comprises a coil 3 that is wound on an insulating spool 2 and is arranged in a magnetically conductive stator unit 4 and a magnet armature 5 that can move toward the stator unit 4 against the force of at least one return spring 6 when the coil 3 is energized wherein the spool 2 is not held by means of the return spring 6 in the stator unit 4. Instead, additional measures that are not illustrated here are used to secure the spool in the stator unit.

### LIST OF REFERENCE SYMBOLS

1 power-off brake
2 spool
3 coil
4 stator unit
5 magnet armature
6 return spring
7 molded part
8 annular space
9 brake disk
10 brake lining
11 air gap

What is claimed is:

1. A power-off brake (1) comprising:
a magnetically conductive stator unit (4),
an insulating spool (2) in the stator unit (4),
at least one return spring (6) holding the insulating spool (2) in the stator unit (4), and
a coil (3) wound on the insulating spool (2) and arranged in the magnetically conductive stator unit (4), the coil (3) have energized and de-energized states,
a magnet armature (5) movable toward the stator unit (4) against the force of the at least one return spring (6) when the coil (3) is energized.

2. The power-off brake according to claim 1, wherein the spool (2) comprises a molded part (7) that serves as a support surface for one end of the at least one return spring (6).

3. The power-off brake according to claim 2, wherein the at least one return spring (6) is supported on the other end on the magnet armature wherein the length of the at least one return spring (6) and the distance between the molded part (7) and the magnet armature are adjusted to one another such that the at least one return spring is pre-stressed even when the coil is in a de-energized state.

4. The power-off brake according to claim 1, wherein the spool (2) is held exclusively by the at least one return spring (6) in an axial direction in the stator unit (4).

5. The power-off brake according to claim 1, wherein the at least one return spring (6) is a pressure spring.

6. The power-off brake according to claim 5, wherein the stator unit (4) includes an annular space (8), and wherein one single pressure spring is provided that is arranged in the annular space (8) inside the stator unit (4) and radially inside the coil (3).

7. The power-off brake according to claim 5, wherein the stator unit (4) includes an annular space (8), and wherein one single pressure spring is provided that is arranged in the annular space (8) inside the stator unit (4) and radially outside the coil (3).

8. The power-off brake according to claim 5, wherein the stator unit (4) includes an annular space (8), and wherein several pressure springs are provided that are arranged evenly over the 360° angle of the annular space (8) inside the stator unit (4) and radially inside the coil (3).

9. The power-off brake according to claim 5, wherein the stator unit (4) includes an annular space (8), and wherein several pressure springs are provided that are arranged evenly over the 360° angle of the annular space (8) inside the stator unit (4) and radially outside the coil (3).

10. The power-off brake according claim 1, wherein the spool (2) comprises retainer pockets for at least one return spring (6).

11. The power-off brake according claim 1, wherein the spool (2) and the stator unit (4) comprises retainer pockets for at least one return spring (6).

12. The power-off brake according claim 1, wherein at least one return spring (6) is accommodatable in the spool (2) using a form-fit connection.

13. The power-off brake according claim 1, wherein at least one return spring (6) is accommodatable in the spool (2) using a force-fit connection.
